(19) United States
(12) Patent Application Publication
(10) Pub. No.: US 2004/0225576 A1
(43) Pub. Date: Nov. 11, 2004

(54) Method and system for interconnecting electronic marketplaces

(75) Inventors: Yoshihiro Mizuno, Yokohama (JP); Hiromi Tsuruwaka, Yokohama (JP); Hideki Sano, Yokohama (JP); Satoshi Takeuchi, Yokohama (JP); Yo Nakajima, Kunitachi (JP); Osamu Moriya, Yokohama (JP); Masaki Nakaoka, Kawasaki (JP); Yuichi Mashita, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/778,619

(22) Filed: Feb. 13, 2004

(30) Foreign Application Priority Data
Feb. 13, 2003 (JP) 2003-034484

(51) Int. Cl. G06F 17/60

(52) U.S. Cl. 705/26

(57) ABSTRACT

Agreement information created between a participant and another participant of the same or another electronic marketplace center is held in an agreement DB. On the basis of the agreement information, interconnection processing between electronic marketplaces is controlled such that a service system can transfer business data to another service system of another electronic marketplace center, the service system requests business processing to the another service system of the another electronic marketplace center, respond to a request from the another service system of the another electronic marketplace center, or the service system can be provided to the another electronic marketplace center.

### CROSS-REFERENCE TO RELATED APPLICATIONS

The present application claims priority upon Japanese Patent Application No. 2003-34484 filed on Feb. 13, 2003which is herein incorporated by reference.

### BACKGROUND OF THE INVENTION

1. Field of the Invention

The present invention relates to a system and a method for an electronic marketplace, which provides various kinds of business services through a network such as the Internet, and more particularly to a system and a method for transferring business data or business processing requests between different electronic marketplaces.

2. Description of the Related Art

There is an electronic marketplace as means for providing various kinds of business services to corporations, companies and enterprises through a network such as the Internet, and such electronic marketplaces have recently been established at various places. An exemplary electronic marketplace is disclosed in Japanese Patent Application Laid-open Publication No. Hei11-110456, in which by an electronic marketplace center offered by an electronic marketplace provider, a service provider makes an agreement with the electronic marketplace provider and installs a service system in the electronic marketplace center to provide various business services to a user. The user such as a company makes an agreement with the electronic marketplace provider to obtain a basic right to use the electronic marketplace center and makes an agreement with a certain service provider to connect to the service system to carry out desired business.

Japanese Patent Application Laid-open Publication No. 2002-157533 discloses acceptance and sending of orders of goods between a buyer and a supplier on an electronic commerce marketplace.

However, none of the conventional technologies have disclosed interconnection of a plurality of electronic marketplaces. In view of recent business diversification, it is difficult to deal with all business operations which the user needs only by services provided at one electronic marketplace. Under the present circumstances in which the electronic marketplaces have been established at various places, the customers are not always participants of the same electronic marketplace.

### SUMMARY OF THE INVENTION

An object of the present invention is to provide a system and a method for interconnecting a plurality of electronic marketplaces to enable safe and smooth use of business services provided at the other electronic marketplace by a user who uses an electronic marketplace.

Another object of the present invention is to provide a system and a method for interconnecting a plurality of electronic marketplaces to enable safe and smooth trades between a user who uses an electronic marketplace and a user who participates in a different electronic marketplace.

According to one aspect of the present invention, agreement information created between the participant of an electronic marketplace and the participant of the same or other electronic marketplace is held at the electronic marketplace and, based on the agreement information, information managed at the electronic marketplace or information handled in business services provided at the electronic marketplace is transferred. The participants include organization users and an individual user who uses the business services, an electronic marketplace provider who is a proprietor to provide an electronic marketplace, a service provider who is a proprietor to provide business services on the electronic marketplace.

Specifically, agreement information is prepared, which contains electronic marketplace interconnection agreement information exchanged between the provider of the first electronic marketplace system and the provider of the second electronic marketplace system to transfer various kinds of information between the first electronic marketplace system and the second electronic marketplace system; service interconnection agreement information exchanged between the provider of the first service system and the provider of the second service system to transfer business information between the first service system which provides business services in the first electronic marketplace system and the second service system which provides business services in the second electronic marketplace system; electronic marketplace use agreement information which the first user exchanges with the provider of the first electronic marketplace system to use the first electronic marketplace system; service providing agreement information which the provider of the first service system exchanges with the provider of the first electronic marketplace system to provide business services in the first electronic marketplace system; service use agreement information which the first user exchanges with the provider of the first service system to utilize business services provided by the first electronic marketplace system, and trading agreement information which the first user exchanges with the second user who utilizes the second service system to carry out business with the second user by using an information transfer function of the first service system. Reference is made to the agreement information when at least one selected from: business data interchange for transferring business data between the first service system and the second service system; business process connection for requesting business processing carried out by each of the service systems and responding to a request; and service providing for providing the services of the first service system in the second electronic marketplace system, is carried out, and business information is transferred between the first electronic marketplace system and the second electronic marketplace system if presence of the agreement information is verified.

According to another aspect of the present invention, a plurality of electronic marketplaces are interconnected to enable a user who uses an electronic marketplace to safely and smoothly use business services provided at another electronic marketplace.

According to further aspect of the present invention, a plurality of electronic marketplaces are interconnected to enable a user who uses an electronic marketplace to safely and smoothly carry out trades with a user who participates in the other electronic marketplace.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a configuration view of an entire electronic marketplace system which includes an electronic marketplace center according to the present invention;

FIG. 2 is a processing flowchart of business data interchange according to the present invention;

FIG. 3 is a processing flowchart of business process connection according to the present invention;

FIG. 4 is a processing flowchart of service providing according to the present invention;

FIG. 5 is a view showing an example of an interconnection message in the business data interchange according to the present invention;

FIGS. 6A and 6B are views showing examples of interconnection messages in the business process connection according to the present invention;

FIG. 7 is an example of an interconnection message in providing services according to the present invention;

FIG. 8 is a processing flowchart of creating each piece of agreement information according to the present invention;

FIGS. 9A and 9B are views showing examples of electronic marketplace interconnection agreements;

FIGS. 10A and 10B are views showing examples of service interconnection agreements;

FIGS. 11A and 11B are views showing examples of trading agreements;

FIGS. 12A and 12B are views showing examples of electronic marketplace use agreements;

FIGS. 13A and 13B are views showing examples of service providing agreements;

FIGS. 14A and 14B are views showing examples of service use agreements; and

FIGS. 15A and 15B are views showing examples of agreement messages in the agreement creation processing according to the present invention.

### DETAILED DESCRIPTION OF THE INVENTION

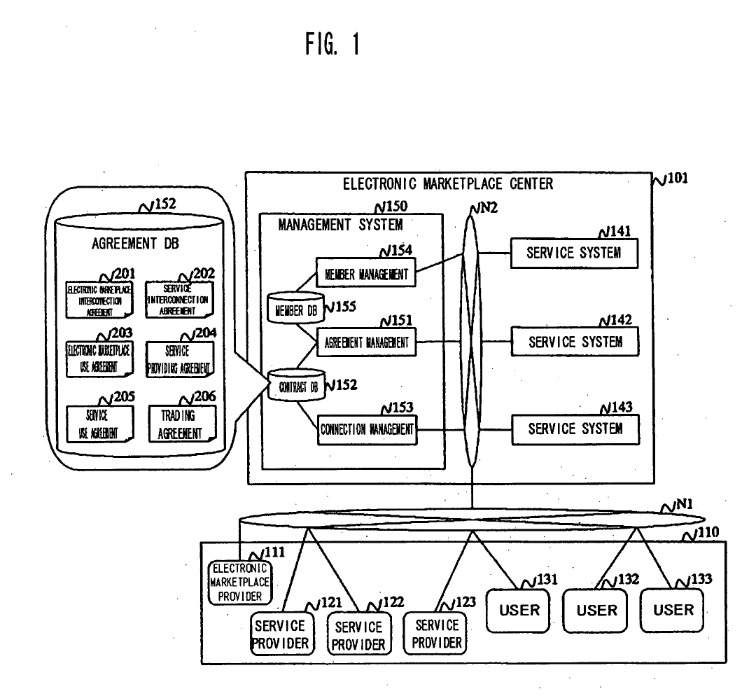

Embodiments of the present invention will be described with reference to the accompanying drawings. However, the present invention is not limited to the embodiment. For example, a management system 150 and at least one of service systems 141 to 143 in FIG. 1 may be included in one and same device.

FIG. 1 shows an electronic marketplace center (system) 101 according to the present invention, and the entire configuration of a system which constitutes an electronic marketplace to provide and implement various business services by using the center. In FIG. 1, the electronic marketplace center 101 is provided by an electronic marketplace provider 111 and includes service systems 141 to 143 which provide various business services to users 131 to 133, and a management system 150 which is in charge of administrative control of the entire electronic marketplace. These sections are interconnected through a communication line N2 installed in the electronic marketplace center 101, and connected to the outside of the electronic marketplace center 101 through a communication line N1 connected to the communication line N2. The electronic marketplace is an electronic exchange which provides various kinds of business services to the user through a network such as the Internet. Specifically, it supports the transfer (transmission/reception) of data necessary for providing business services to the user.

The electronic marketplace provider 111 carries out administration control of the entire electronic marketplace. For example, it connects to the management system 150 through the communication lines N1 and N2 to monitor the operation condition of each system. The service providers 121 to 123 make agreements with the electronic marketplace provider 111 to install one or a plurality of service systems 141 to 143 in the electronic marketplace center 101 and to provide various business services to the users 131 to 133, while connecting to a service system which the company provides through the communication lines N1 and N2 to carry out management work regarding business services. The users 131 to 133 make agreements with the electronic marketplace provider 111 to obtain basic rights to use the electronic marketplace center 101, and make agreements with any of the service providers 121 to 123 to connect to corresponding service systems through the communication lines N1 and N2 to carry out desired work. Here, the electronic marketplace provider 111 may install and provide common business services, such as providing a common display to access the electronic marketplace center 101 to the users 131 to 133 as any of the service systems 141 to 143 differently from the service providers 121 to 123 on the electronic marketplace.

The management system 150 sets the electronic marketplace provider 111, the service providers 121 to 123 and the users 131 to 133 as participants 110, manages basic information such as names or addresses regarding the participants 110 and authentication information to access the electronic marketplace 101 in a member database (member DB) 155, and manages agreement information between the participants 110 and agreement information between any one of the participants 110 and any one of participants in another electronic marketplace center in an agreement database (agreement DB) 152. In management, in the case of member management 154, the information of the participant 110 is taken out from the member DB 155 to be provided in response to information registration in the member DB 155 and enquires from the service systems 141 to 143, and reference is made to the member DB 155 to carry out authentication when the participant 110 accesses the electronic marketplace 101. In the case of agreement management 151, the agreement information is registered (writing) in the agreement DB152 and taken out (read) from the agreement DB 152 to be provided in response to requests from the service systems 141 to 143 and the participant 110. In interconnection management 153, based on the agreement information, information transfer to connect with the other electronic marketplace center or a service system provided in the other electronic marketplace center, a processing request, and a processing response to meet the processing request are carried out.

Various kinds of agreement information stored in the agreement DB 152 specifically mean: an agreement (electronic marketplace interconnection agreement 201) exchanged between the electronic marketplace providers who are providers of electronic marketplace centers to transfer various kinds of information between the electronic marketplace center 101 and the other electronic marketplace center; an agreement (service interconnection agreement 202) exchanged between the service providers who are providers of each service systems to transfer business information or the like handled by each of the service systems which provide business services in another electronic marketplace center and any one of the service systems 141 to 143 which provide business services in the electronic marketplace center 101; an agreement (electronic marketplace use agreement 203) made between the electronic marketplace provider 111 who is a provider of the electronic marketplace center 101 and the users 131 to 133 as a basic agreement to allow the users 131 to 133 to use the electronic marketplace center; an agreement (service providing agreement 204) made between the electronic marketplace provider 111 who is a provider of the electronic marketplace center 101 and the service providers 121 to 123 to allow the service providers 121 to 123 to provide business services in the service systems 141 to 143 of the electronic marketplace center 101; an agreement (service use agreement 205) made between the service providers 121 to 123 who are providers of the service systems 141 to 143 and the users 131 to 133 to allow the users 131 to 133 to use the service systems 141 to 143 provided in the electronic marketplace center 101; an agreement (trading agreement 206) made between the users to allow the users 131 to 133 to carry out work such as acceptance and sending of orders with a user who uses the same service system by using a function such as an information transfer function of any one of the service systems which have made the use agreement based on the service use agreement 205, or a user who uses a service system which has made an interconnection agreement with the service system based on the service interconnection agreement 202, and the like.

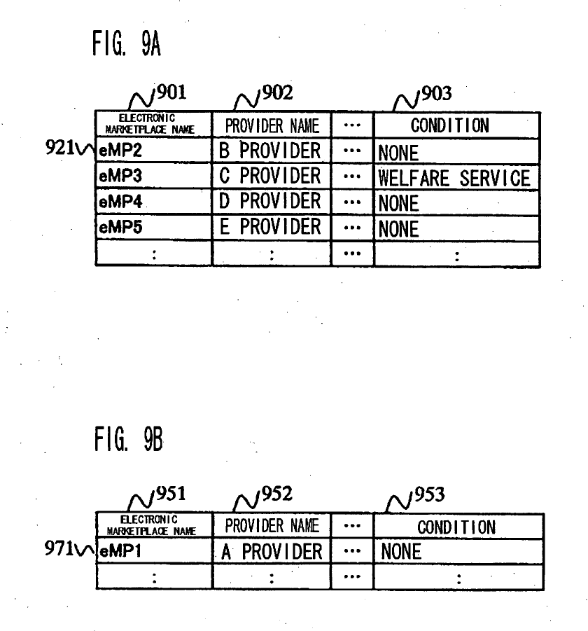

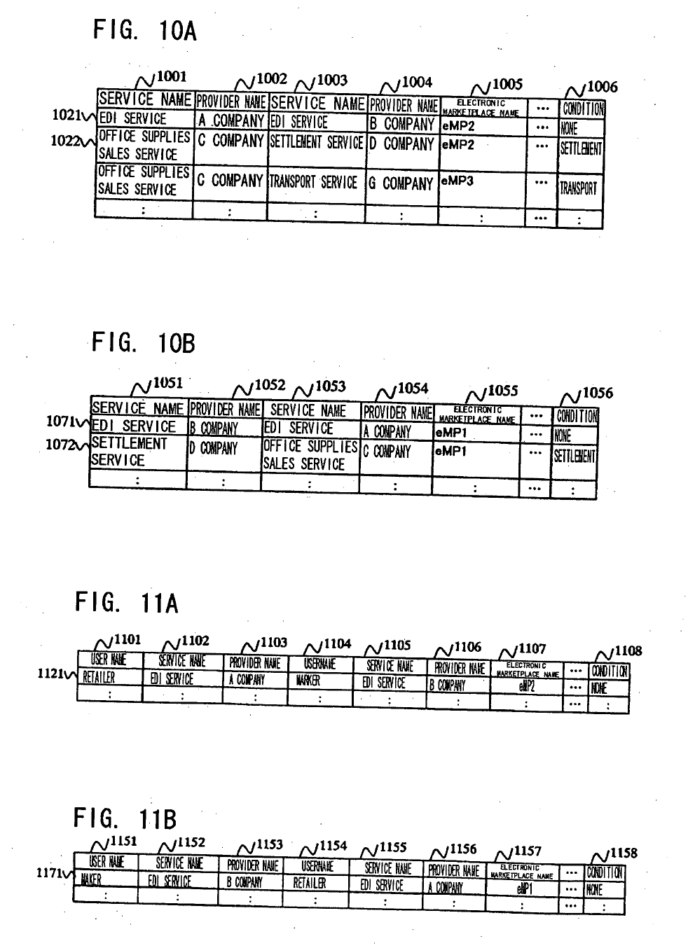

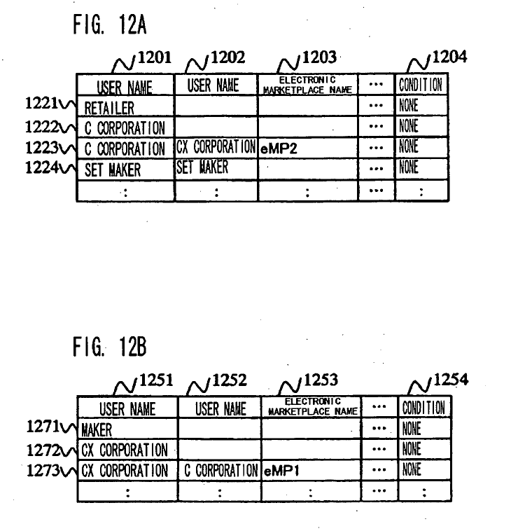

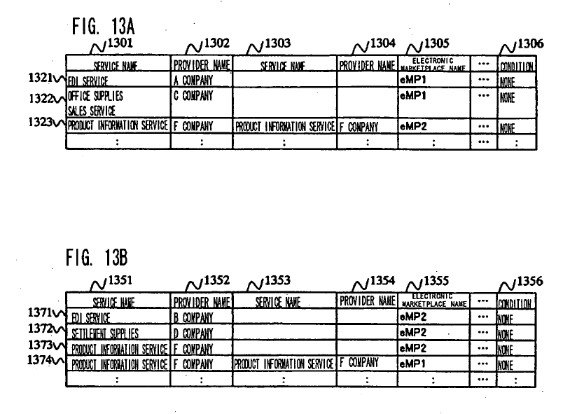

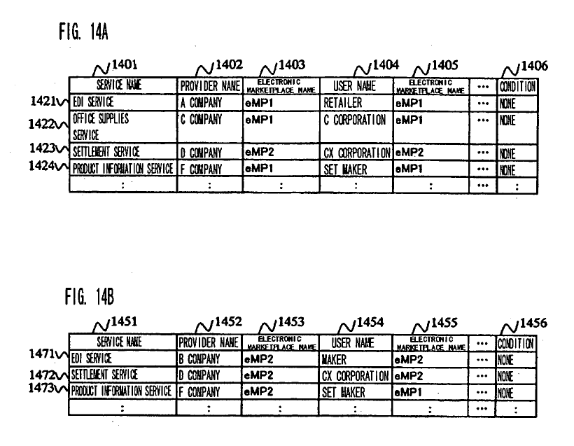

Agreement examples are shown in FIGS. 9A to 14B. In each shown example, the electronic marketplace center can be uniquely specified by using its name as an identifier. The service system can be uniquely specified by using the combination of its name, the name of its provider, and the name of the electronic marketplace center in which the service system is provided as an identifier. The user can be uniquely specified by using the user's name and the name of the electronic marketplace center which the user uses as identifiers. FIGS. 9A and 9B show the examples of electronic marketplace interconnection agreements 201a and 201b, which include electronic marketplace names 901 and 951 indicating the names of electronic marketplace centers to be connected with, provider names 902 and 952 indicating the provider names of the electronic marketplace centers, and conditions 903 and 953 indicating conditions regarding interconnection between electronic marketplace centers such as definition of a communication process. FIGS. 10A and 10B show the examples of service interconnection agreements 202a and 202b, which include service names 1001 and 1051 indicating the names of the service systems of own electronic marketplace centers to be connected with, provider names 1002 and 1052 indicating the provider names of the service systems, service names 1003 and 1053 indicating the names of service systems to be connected with the service systems, provider names 1004 and 1054 indicating the provider names of the opponent service systems, electronic marketplace names 1005 and 1055 indicating the names of electronic marketplace names to which the opponent service systems are provided, and conditions 1006 and 1056 indicating conditions regarding interconnection between service systems such as limitation of interconnection work. FIGS. 11A and 11B show the examples of trading agreements 206a and 206b, which include user names 1101 and 1251 indicating the user names of own electronic marketplace centers to make trading agreements with, service names 1102 and 1152 indicating the names of service systems which is used by the users making the trading agreements with, provider names 1103 and 1153 indicating the provider names of the service systems, user names 1104 and 1154 indicating the names of the opponent users to make the trading agreements with, a service name 1105, a provider name 1106 and an electronic marketplace name 1107, a service name 1155, a provider name 1156 and an electronic marketplace name 1157 which specify the service systems used by the users to make the trading agreements with, and conditions 1108 and 1158 indicating conditions regarding trades such as limitation of information exchanged between the users. FIGS. 12A and 12B show the examples of electronic marketplace use agreements 203a and 203b, which include user names 1201 and 1251 indicating the names of the users of electronic marketplace centers, and conditions 1204 and 1254 indicating conditions regarding use, and further, users are specified by a user name 1202 and an electronic marketplace name 1203, a user name 1252 and an electronic marketplace name 1253 when the users of the other electronic marketplace center use the own electronic marketplace center or in the case reverse thereto. FIGS. 13A and 13B show the examples of service providing agreements 204a and 204b, which include service names 1301 and 1351 indicating the names of service systems to be provided, provider names 1302 and 1352 indicating the provider names of the service systems, and conditions 1306 and 1356 indicating conditions regarding service providing, and service systems are specified by a service name 1303, a provider name 1304 and an electronic marketplace name 1305, a service name 1353, a provider name 1354 and an electronic marketplace name 1355 when service systems provided at the other electronic marketplace center are provided by the own electronic marketplace center or vice versa. FIGS. 14A and 14B show the examples of service use agreements 205a and 205b, which include a service name 1401, a provider name 1402 and an electronic marketplace name 1403, a service name 1451, a provider name 1452 and an electronic marketplace name 1453 which specify service systems, a user name 1404 and an electronic marketplace name 1405, a user name 1454 and an electronic marketplace name 1455 which specify the users of service systems, and conditions 1406 and 1456 indicating conditions such as limitation regarding the use of the service systems.

In FIG. 1, because of limited space, the service providers 121 to 123, the users 131 to 133 and the service systems 141 to 143 are respectively three in number, but there is no particular limitation on the numbers.

In the electronic marketplace center 101, interconnection with the other electronic marketplace center (interconnection between electronic marketplaces) can be carried out as follows.

According to an aspect of the present invention, interconnection includes the transfer of business data handled by each service system between any one of the service systems 141 to 143 in the electronic marketplace center 101 and any one of the service systems in the other electronic marketplace center (business data interchange), requesting of business processing implemented by each service system or responding to a request between any one of the service systems 141 to 143 in the electronic marketplace center 101 and any one of the service systems in the other electronic marketplace center (business process connection), and providing of any one of the service systems 141 to 143 of the electronic marketplace center 101 in the other electronic marketplace center (service providing).

In the embodiments of interconnection hereinafter, it is assumed that when any one of the participants 110 accesses the electronic marketplace center 101, the member management 154 carries out authentication to determine the participant based on a participant identifier or the like (this processing is described as authentication processing, hereinafter).

The example of carrying out business data interchange among interchange operations between the electronic marketplaces is described below.

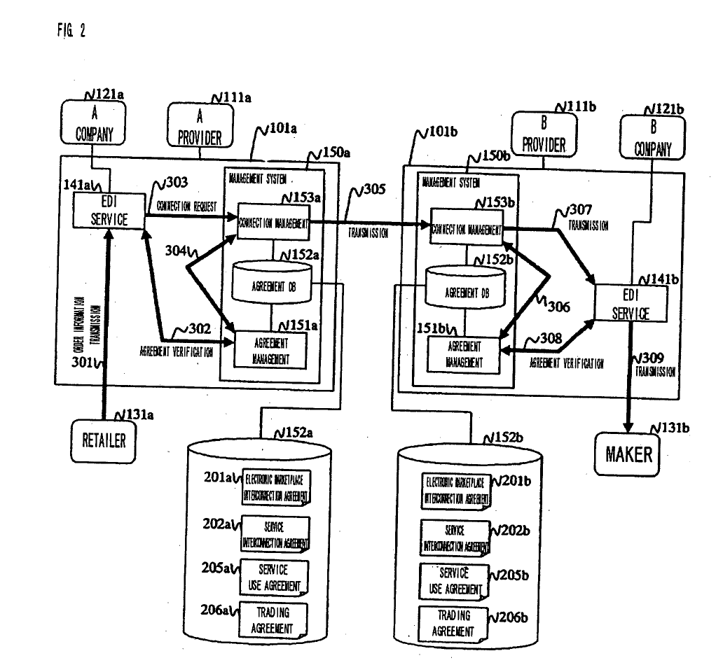

In FIG. 2, reference numerals eMP1 (101a) and eMP2 (101b) denote electronic marketplace centers provided by A and B providers 111a and 111b as electronic marketplace providers, which are similar in system configuration to the electronic marketplace center 101. An EDI (Electronic Data Interchange) service 141a and an EDI service 141b are service systems for providing business services in which an A company 121a and a B company 121b as service providers exchange information regarding acceptance and sending of orders or the like in the eMP1 (101a) and the eMP2 (101b). A retailer 131a and a maker 131b are users who carry out acceptance and sending of orders by using the EDI service 141a and the EDI service 141b.

It is assumed that in the agreement DB 152a and the agreement DB 152b of the eMP1 (101a) and the eMP2 (101b), by later-described agreement creation processing, an electronic marketplace interconnection agreement regarding the eMP1 (101a) and the eMP2 (101b) between the A provider 111a and the B provider 11b, a service interconnection agreement regarding the EDI service 141a and the EDI service 141b between the A company 121a and the B company 121b, and a trading agreement between the retailer 131a and the maker 131b have been registered as electronic marketplace interconnection agreements 921 and 971, service interconnection agreements 1021 and 1071, and trading agreements 1121 and 1171. It is also assumed that before the above registration, electronic marketplace use agreements regarding the use of the electronic marketplace center between the A provider 111a and the retailer 131a and between the B provider 111b and the maker 131b, service providing agreements regarding the providing of the EDI service 141a and the EDI service 141b in the eMP1 (101a) and the eMP2 (101b) between the A provider 111aand the A company 121a and between the B provider 111b and the B company 121b, and service use agreements regarding the use of the EDI service 141a and the EDI service 141b between the A company 121a and the retailer 131a and between the B company 121b and the maker 131b have been registered as electronic marketplace use agreements 1221 and 1271, service providing agreements 1321 and 1371, and service use agreements 1421 and 1471.

In the eMP1 (101a) and the eMP2 (101b), for example, business data interchange is carried out when order information created by the retailer 131 a is transmitted to the maker 131b so as to enable the retailer 131a to order and buy goods from the maker 131b.

Hereinafter, a process in the eMP1 (101a) which is a business data interchange transmission side is described in detail.

First, the retailer 131a creates order information to the maker 131b by a method and a form predetermined by the EDI service 141a, and transmits it to the EDI service 141a (301).

Then, the EDI service system 141a makes an inquiry to the agreement management 15la to verify whether necessary agreement information has been registered in the agreement DB 152a (302). In the verification, the presence of a service use agreement is verified between the retailer 131a which is a transmitter and the A company 121a which is the service provider of the EDI service 141a, and the presence of a trading agreement is verified between the retailer 131a which is a transmitter and the maker 131 which is a receiver, whereby the location of the maker 131b which is a receiver is obtained from the trading agreement. According to the embodiment, information which specifies the transmitter and the receiver is contained in the order information transmitted by the retailer 131a, which can be understood in the EDI service 141a and the EDI service 141b. Specifically, in the verification of the service use agreement, if the combination of the names of the EDI service 141a, the A company 121a which is the service provider thereof and the eMP1 (101a) to which the EDI service 141a is provideed and the names of the retailer 131a obtained by executing authentication processing beforehand for the retailer 131a and the eMP1 (101a) which is an electronic marketplace center used by the retailer 131a matches the service name 1401, the provider name 1402, the electronic marketplace name 1403, the user name 1404 and the electronic marketplace name 1405 of any of the agreement information in the service use agreement 205a shown in FIG. 14A, the presence of an agreement is determined. According to the embodiment, the presence of an agreement is determined because of the matching of agreement information 1421. In this case, the verification of the service use agreement may be carried out before the processing 301 when the retailer 131a accesses the EDI service 141a or the like.

In the verification of the trading agreement, if the combination of the names of the retailer 131a, the EDI service 141a, the A company 121a and the maker 131b matches the user name 1101, the service name 1102, the provider name 1103 and the user name 1104 of any of the agreement information in the trading agreement 206a shown in FIG. 11A, the presence of an agreement is determined. Then, based on the electronic marketplace name 1107, the provider name 1106 and the service name 1105 in the determined agreement information, the identifiers of an electronic marketplace center and a service system which the maker 131b uses are obtained as the location (location information) of the maker 131b. According to the embodiment, the presence of an agreement is determined because of the matching of the agreement information 1121, and the name “eMP2” of the electronic marketplace center, the provider name “B company” of the service system, and the name “EDI service” of the service system are obtained as the location information of the maker 131b. In the verification of the trading agreement, in the case that the order information is required to be transmitted to the other electronic marketplace center, the EDI service 141a transfers the order information and the location information to the interconnection management 153a to request the transmission of the order information to the electronic marketplace center and the service system which the maker 131b uses (303).

The interconnection management 153a makes an inquiry to the agreement management 151a to verify whether an agreement necessary between the electronic marketplace center and the service system, which are receivers, has been registered in the agreement DB 152a based on the location information (304). In the verification, the presence of an electronic marketplace interconnection agreement with the eMP2 (101b) and a service interconnection agreement between the EDI service 141a and the EDI service 141b is checked. Specifically, in the verification of the electronic marketplace agreement, the presence of an agreement is determined if the name of the eMP2 (101b) matches any of the electronic marketplace name 901 of the agreement information in the electronic marketplace interconnection agreement 201a shown in FIG. 9A. In the embodiment, because of the matching of agreement information 921, the presence of an agreement is determined. In the verification of a service interconnection agreement, the presence of an agreement is determined if the combination of the names of the EDI service 141a, the A company 121a, the EDI service 141b, the B company 121b and the eMP2 (101b) matches any of the agreement information in the service interconnection agreement 202a shown in FIG. 10A, that is, the service name 1001, the provider name 1002, the service name 1003, the provider name 1004, and the electronic marketplace name 1005 of. According to the embodiment, the presence of an agreement is determined because of the matching of agreement information 1021.

If the presence of an agreement is verified in the processing 304, data (interconnection message) to be transmitted to the electronic marketplace center which the maker 131b uses is created based on order information and location information, and then transmitted (305). In the embodiment, the interconnection management 153a creates an interconnection message and then transmits it to the eMP2 (101b).

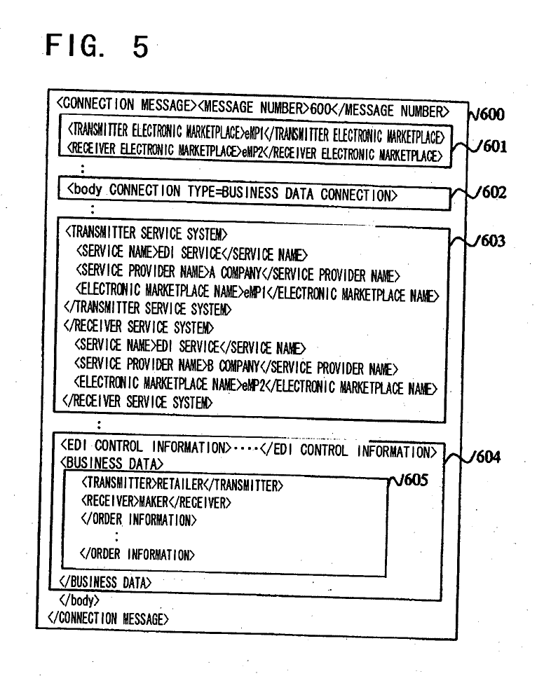

FIG. 5 shows an example of an interconnection message. A interconnection message 600 in FIG. 5 is an example of an interconnection message created by a tagged format such as an extensible markup language (XML). A interconnection message described below is similar. The interconnection message 600 includes an information part 601 which specifies transmitter and receiver electronic marketplace centers, an information part 602 (“business data interchange” according to the embodiment) which specifies a kind of interconnection between the electronic marketplace centers, an information part 603 which specifies a service system to be connected with in business data interchange, and an information part 604 to be understood and processed in a service system containing business data 605 (order information transmitted from the retailer 131a according to the embodiment) exchanged between the users.

Next, the processing of receiving the interconnection message 600 and transmitting order information to the maker 131b in the eMP2 (101b) will be described in detail.

The interconnection management 153b obtains information regarding the transmitter electronic marketplace center (“eMP1” in the embodiment), the kind of interconnection between the electronic marketplace centers (“business data interchange” in the embodiment), and the service system to be connected in the business data interchange. Then, an inquiry is made to the agreement management 151b based on the information to verify whether an agreement necessary between the transmitter electronic marketplace center and the service system has been registered in the agreement DB 152b (306). In the verification, the presence of an electronic marketplace interconnection agreement with the eMP1 and a service interconnection agreement between the EDI service 141b and the EDI service 141a is verified. Specifically, in the verification of the electronic marketplace agreement, the presence of an agreement is determined if the name of the eMP1 (101a) matches any one of the electronic marketplace name 951 of the agreement information in the electronic marketplace interconnection agreement 201b shown in FIG. 9B. In the embodiment, because of the matching of agreement information 971, the presence of an agreement is determined. In the verification of a service interconnection agreement, the presence of an agreement is determined if the combination of the names of the EDI service 141b, the B company 121b, the EDI service 141a, the A company 121a and the eMP1 (101a) obtained from the interconnection message matches any of the agreement information in the service interconnection agreement 202b shown in FIG. 10B including the service name 1051, the provider name 1052, the service name 1053, the provider name 1054, and the electronic marketplace name 1055. In the embodiment, the presence of an agreement is determined because of the matching of agreement information 1071.

If the presence of an agreement is verified in the processing 306, the interconnection management 153b extracts the information part 604 to be understood and processed in the service system containing the business data 605 (order information sent from the retailer 131a in the embodiment) exchanged between the service systems from the interconnection message, and transmits the information part 604 to the receiver EDI service 141b (307).

The EDI service 141b makes an inquiry to the agreement management 151b to verify whether necessary agreement information has been registered in the agreement DB 152b (308). In the verification, the presence of a service use agreement is verified between the receiver maker 131b and the B company which is a service provider of the EDI service 141b, and the presence of a trading agreement is verified between the transmitter retailer 131a and the receiver maker 131b. Specifically, in the verification of the service use agreement, the presence of an agreement is determined if the combination of the names of the EDI service 141b, the B company 121b which is the service provider thereof and the eMP2 (101b) which provides the EDI service 141b with the names of the maker 131b and the eMP2 (101b) which is an electronic marketplace center used by the maker 131b matches any of the agreement information in the service use agreement 205b shown in FIG. 14B including the service name 1451, the provider name 1452, the electronic marketplace name 1453, the user name 1454 and the electronic marketplace name 1455. In the embodiment, the presence of an agreement is determined because of the matching of agreement information 1471. In the verification of a trade relation, the presence of an agreement is determined if the combination of the names of the maker 131b, the EDI service 141b, the B company 121b, the retailer 131a, the EDI service 141a, the A company and the eMP1 (101a) matches any of the agreement information in the trading agreement 206b shown in FIG. 11B including the user name 1151, the service name 1152, the provider name 1153, the user name 1154, the service name 1155, the provider name 1156 and the electronic marketplace name 1157. In the present invention, the presence of an agreement is determined because of the matching of the agreement information 1171.

If the presence of an agreement is verified in the processing 308, the EDI service 141b extracts the business data 605, that is, the order information among the information previously received from the interconnection management 153b, and transmits the business data 605 to the maker 131b (309).

According to the business data interchange of the present invention, the user of the service system can carry out trades with the customer who uses the other electronic marketplace center through the currently used electronic marketplace center and service system. Thus, there is no need to prepare an environment for connection to a service system or an electronic market center in accordance with a customer such as a new customer, or change a connection target, and, at the same time, work can be simplified and information exchange and work can be carried out without increasing work costs.

Furthermore, according to the present invention, the use rate of the service system by the user is increased, whereby the service provider or the electronic marketplace provider can activate services or the electronic marketplace, and increase profits which accompany the use of services and the electronic marketplace. Additionally, since it is not necessary to increase users who have direct agreements, the number of users can be increased without increasing sales expansion costs for expansion of sales.

An example of implementing the business process connection among the interconnection operations between the electronic marketplaces is described below.

In FIG. 3, eMP1 (101a) and eMP2 (101b) are electronic marketplace centers provided by A and B providers 111a and 111b as electronic marketplace providers, respectively. System configuration thereof is similar to the electronic marketplace center 101. An office supplies sales service 141c is a service system in which a C company 121c which is a trading house or the like sells office supplies such as stationery in the eMP1 (101a), as a service provider. A settlement service 141d is a service system in which a D company 121d which is a financial institution such as a bank carries out fund settlement such as transfer in the eMP2 (101b), as a service provider. A C corporation 131c buys office supplies as a user of the office supplies sales service 141c. It is also assumed that the company 121c is a user of the settlement service 141d and makes payment for material orders or the like.

It is assumed that in the agreement DB 152a and the agreement DB 152b of the eMP1 (101a) and the eMP2 (101b), by later-described agreement creation processing, an electronic marketplace interconnection agreement regarding the eMP1 (101a) and the eMP2 (101b) between the A provider 111a and the B provider 111b, and a service interconnection agreement regarding the office supplies sales service 141c and the settlement service 141d between the C company 121c and the D company 121d have been registered as electronic marketplace interconnection agreements 921 and 971, and service interconnection agreements 1022 and 1072. It is also assumed that before the above registration, electronic marketplace use agreements between the A provider 111a and the C corporation 131c and between the B provider 111b and the C corporation 131c, service providing agreements regarding the providing of the office supplies sales service 141c and the settlement service 141d in the eMP1 (101a) and the eMP2 (101b) between the A provider 111a and the C company 121c and between the B provider 111b and the D company 121d, and service use agreements regarding the use of the office supplies sales service 141c and the settlement service 141d between the C company 121c and the C corporation 131c and between the D company 121d and the C corporation 131c have been registered as electronic marketplace use agreements 1222 and 1223, electronic marketplace use agreements 1272 and 1273, service providing agreements 1322 and 1372, and service use agreements 1422, 1423 and 1472.

In the eMP1 (101a) and the eMP2 (101b), for example, the C corporation 131c accepts a charge regarding purchased goods in the office supplies sales service 141c. Subsequently, business process connection is carried out in the settlement service 141d when bank transfer is requested to make a payment. Hereinafter, a process regarding the business process connection is described in detail.

First, the C corporation 131c accepts that a payment of a presented charge regarding purchased goods in the office supplies sales service 141c to be made by the predetermined method of the office supplies sales service 141c (401).

Then, the office supplies sales service 141c makes an inquiry to the agreement management 151a to verify whether necessary agreement information has been registered in the agreement DB 152a (402). In the verification, service systems which have service interconnection agreements with the office supplies sales service 141c under specific conditions are retrieved to verify the registration of a service use agreement between any one of the service systems and the C corporation 131c. According to the embodiment, the specific conditions indicate the execution of settlement work after the work in the office supplies sales service 141c is processed. Specifically, in the retrieval of the service systems, a relevant service system is obtained which is indicated by the service name 1003, the provider name 1004, and the electronic marketplace name 1005 of agreement information set as “settlement” in the condition 1006 among agreement information in which the names of the office supplies sales service 141c and the C company 121c, which is a service provider thereof, match the service name 1001 and the provider name 1002 in the service interconnection information shown in FIG. 10A. In the embodiment, the agreement information 1022 matches the retrieval, and a service system “settlement service” provided by the “D company” in the electronic marketplace center “eMP2” is obtained as a relevant service system. Then, regarding the C corporation 131c, a name in the electronic marketplace center “eMP2” is obtained from the electronic marketplace use agreement 203a. Specifically, the user name 1202 of agreement information is obtained in which the name of the C corporation 131c and the name “eMP2” of the electronic marketplace center match the user name 1201 and the electronic marketplace name 1203 in the electronic marketplace use agreement 203a shown in FIG. 12A. In the present invention, the name “CX Corporation” of the C corporation 131c in the electronic marketplace center “eMP2” is obtained because of the matching of agreement information 1223. Then, in the verification of the service use agreement, the presence of an agreement is determined if the name “settlement service” of the service system, the provider name “D company” of the service system, the name “eMP2” of the electronic marketplace center which provides the service system, the name “CX Corporation” of the C corporation 131c in the electronic marketplace center “eMP2”, and the name “eMP2” of the electronic marketplace center in which the C corporation 131c uses the service system, which are obtained bits of information of the service system, match the service name 1401, the provider name 1402, the electronic marketplace name 1403, the user name 1404 and the electronic marketplace name 1405 of any of the agreement information in the service use agreement 205a shown in FIG. 14A. In the present embodiment, the presence of an agreement is determined because of the matching of the agreement information 1423. If the verification of a service use agreement is unnecessary because of the service system to be connected, only retrieval of service system is carried out. If a plurality of agreement information match in the processing 402, the number of service systems to be connected in work thereafter must be decided to one. As an example of this decision, a list of information of the service system targeted for an agreement is presented to the C corporation 131c to enable a decision so that the C corporation 131c can make a choice.

If the presence of an agreement is verified in the processing 402, the office supplies sales service 141c passes information necessary for the settlement of the C corporation 131c (information to request transfer in the embodiment), information regarding the settlement service 141d to be connected with (name “settlement service” of the service system, provider name “D company”, and name “eMP2” of the electronic marketplace center) to the interconnection management 153a (403).

The interconnection management 153a makes an inquiry to the agreement management 151a to verify whether an agreement necessary between the electronic marketplace center and the service system which are connected with for work has been registered in the agreement DB 152a based on the received information (404). In the verification, the presence of an electronic marketplace interconnection agreement with the eMP2 (101b) and the presence of a service interconnection agreement between the office supplies sales service 141c and the settlement service 141d are checked to obtain the name of the C corporation 131c in the eMP2 (101b) from the electronic marketplace use agreement 203a. Specifically, in the verification of the electronic marketplace interconnection agreement, the presence of an agreement is determined if the name of the eMP2 (101b) matches the electronic marketplace name 901 of any one of the agreement information in the electronic marketplace interconnection agreement 201a shown in FIG. 9A. In the embodiment, because of the matching of agreement information 921, the presence of an agreement is determined. In the verification of a service interconnection agreement, the presence of an agreement is determined if the combination of the names of the office supplies sales service 141c, the C company 121c, the settlement service 141d, the D company 121d and the eMP2 (101b) matches any of the service name 1001, the provider name 1002, the service name 1003, the provider name 1004, and the electronic marketplace name 1005 of the agreement information in the service interconnection agreement 202a shown in FIG. 10A. In the embodiment, the presence of an agreement is determined because of the matching of agreement information 1022. Further, the user name 1202 of the agreement information is obtained in which the names of the C corporation 131c and the eMP2 (101b) match the user name 1201 and the electronic marketplace name 1203 in the electronic marketplace use agreement 203a shown in FIG. 12A. In the embodiment, the name “CX Corporation” of the C corporation 131c in the eMP2 (101b) is obtained because of the matching of the agreement information 1223. Here, in the acquisition of the identifier of the C corporation 131c in the eMP2 (101b), the identifier obtained in the processing 402 may be passed to the office supplies sales service 141c by the agreement management 151a, and the identifier may be further passed to the interconnection management 153a in the processing 403.

If the presence of an agreement is verified in the processing 404, interconnection message which contains a settlement request to the settlement service 141d is created based on the received information, transmitted to the eMP2 (101b), and the process waits for the notice of the completion of processing which includes the result of work in the settlement service 141d (405).

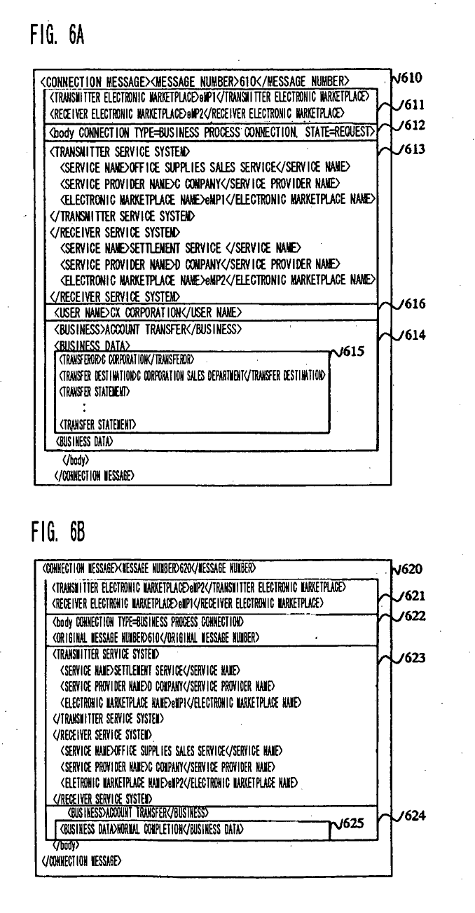

FIG. 6A shows an example of an interconnection message created in the eMP1 (101a). A interconnection message 610 comprises an information part 611 which specifies transmitter and receiver electronic marketplace centers, an information part 612 (“business process connection” in the embodiment) which specifies a kind of interconnection between the electronic marketplace centers, an information part 613 which specifies a service system to be connected with in business process connection, an information part 614 to be understood and processed in a service system containing business data 615 (data regarding transfer request from the C corporation 131c which is necessary for work carried out in the settlement service 141d in the embodiment), and identifier information 616 of the C corporation 131c in the eMP2 (101b).

Next, the process of receiving the interconnection message 610 and carrying out settlement in the settlement service 141d in the eMP2 (101b) will be described in detail.

The interconnection management 153b obtains information regarding the transmitter electronic marketplace center, the kind of interconnection between the electronic marketplace centers (“business process connection” in the embodiment), and the service system to be connected with in the business process connection. Then, an inquiry is made to the agreement management 151b based on the information to verify whether an agreement necessary between the transmitter electronic marketplace center and the service system has been registered in the agreement DB 152b (406). In the verification, the presence of an electronic marketplace interconnection agreement with the eMP1 (101a) which is a transmitter electronic marketplace center, a service interconnection agreement between the office supplies sales service 141c and the settlement service 141d, and an electronic marketplace use agreement between the C corporation 131c and eMP2 (101b) is verified. Specifically, in the verification of the electronic marketplace agreement, the presence of an agreement is determined if the name of the eMP1 (101a) obtained from the interconnection message 610 matches the electronic marketplace name 951 of any one of the agreement information in the electronic marketplace interconnection agreement 201b shown in FIG. 9B. In the embodiment, because of the matching of agreement information 971, the presence of an agreement is determined. In the verification of a service interconnection agreement, the presence of an agreement is determined if the combination of the names of the settlement service 141d, the D company 121d, the office supplies sales service 141c, the C company 121c and the eMP1 (101a) obtained from the interconnection message 610 matches any of the service name 1051, the provider name 1052, the service name 1053, the provider name 1054, and the electronic marketplace name 1055 of the agreement information in the service interconnection agreement 202b shown in FIG. 10B. According to the embodiment, the presence of an agreement is determined because of the matching of agreement information 1072. In the verification of an electronic marketplace use agreement, the presence of an agreement is determined if the name of the C corporation 131c obtained from the identifier information 616 of the interconnection message 610 matches the user name 1251 of any of the agreement information in the electronic marketplace use agreement 203b shown in FIG. 12B. In embodiment, the presence of an agreement is determined because of the matching of the agreement information 1272.

If the presence of an agreement is verified in the processing 406, the interconnection management 153b extracts the information part 614 to be understood and processed in the service system containing the business data 615 exchanged between the service systems from the interconnection message 610, transmits the information part 614 to the settlement service 141d which is a receiver, and waits for the notice of the completion of a process including the result of work processing from the settlement service 141d (407).

The settlement service 141d makes an inquiry to the agreement management 151b to verify whether necessary agreement information has been registered in the agreement DB 152b (408). In the verification, the presence of a service use agreement is verified between the C corporation 131c which is a user that requests work processing and the D company 121d which is a service provider of the settlement service 141d. Specifically, the presence of an agreement is determined if the combination of the names of the settlement service 141d, the D company 121d which is the service provider thereof, and the eMP2 (101b) which provides the settlement service 141d and the names of the C corporation 131c and the eMP2 (101b) which is an electronic marker place center used by the C corporation 131c for the settlement service 141d, matches any of the service name 1451, the provider name 1452, the electronic marketplace name 1453, the user name 1454 and the electronic marketplace name 1455 of the agreement information in the service use agreement 205b shown in FIG. 14B. In the embodiment, the presence of an agreement is determined because of the matching of agreement information 1472.

If the presence of an agreement is verified in the processing 408, the settlement service 141d carries out settlement such as bank transfer based on the information part 614 previously received from the interconnection management 153b (409).

If settlement is completed in the processing 409, the settlement service 141d transmits the notice of the completion of the processing including the result of the settlement to the interconnection management 153b (410).

The interconnection management 153b which has waited for the notice of the completion in the processing 407 receives the completion notice in the processing 410, creates interconnection message as a response to the transmission processing 405 of the interconnection message 610, and transmits the message to the eMP1 (101a) (411).

FIG. 6B shows an example of an interconnection message created in the eMP2 (101b). A interconnection message 620 comprises an information part 624 which indicates a response to the interconnection message 610 and which is understood and processed in a service system including business data 625, which is a result of settlement in the settlement service 141d, in an information part 622 or the like which specifies the kind of interconnection between the electronic marketplace centers (“business process connection” according to the embodiment) In other information parts 621 and 623, the transmitter and the receiver 611 and 613 of the interconnection message 610 are reversely set.

Next, the processing of receiving the interconnection message 620 in the eMP1 (101a) will be described in detail.

The interconnection management 153a which has waited for the notice of the completion in the processing 405 receives the interconnection message 620, extracts the information part 624 indicating the completion notice which contains the business data 625 as the processing result from the interconnection message 620, and transmits the information part 624 to the office supplies sales service 141c as a response to the processing 403 (412).

Upon the reception of the completion notice, the office supplies sales service 141c notifies the completion of the settlement as a processing response to the charge acceptance of the processing 401 to the company 131c (413).

In the foregoing business process connection, in order to reinforce the verification of the agreement information, agreement verification similar to that of the processing 406 may be carried out before the processing 411, agreement verification similar to the processing 404 may be carried out before the processing 412, and agreement verification similar to the processing 402 may be carried before the processing 413.

According to the present invention, the business process connection enables the user of the service system to consistently carry out business operations provided by the plurality of electronic marketplace centers and the plurality of service systems. Thus, it is possible to enhance business operation convenience and efficiency.

Furthermore, by providing an environment in which a plurality of business operations can be consistently carried out, the service provider of the service system or the electronic marketplace provider of the electronic marketplace center can differentiate itself from the other service system or the other electronic marketplace center and provide added values, thus, attracting users and increasing profits.

An example of executing service providing among interconnection operations between the electronic marketplace centers is described below.

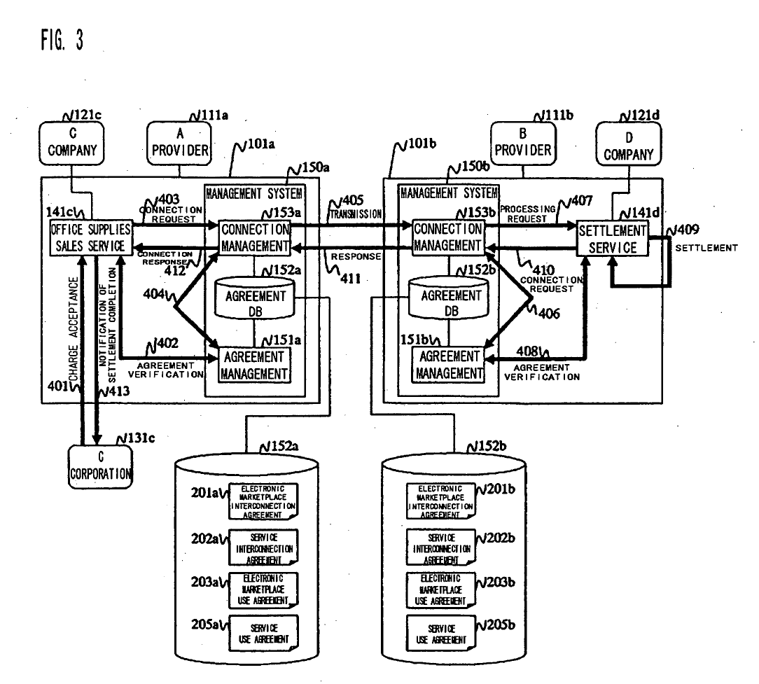

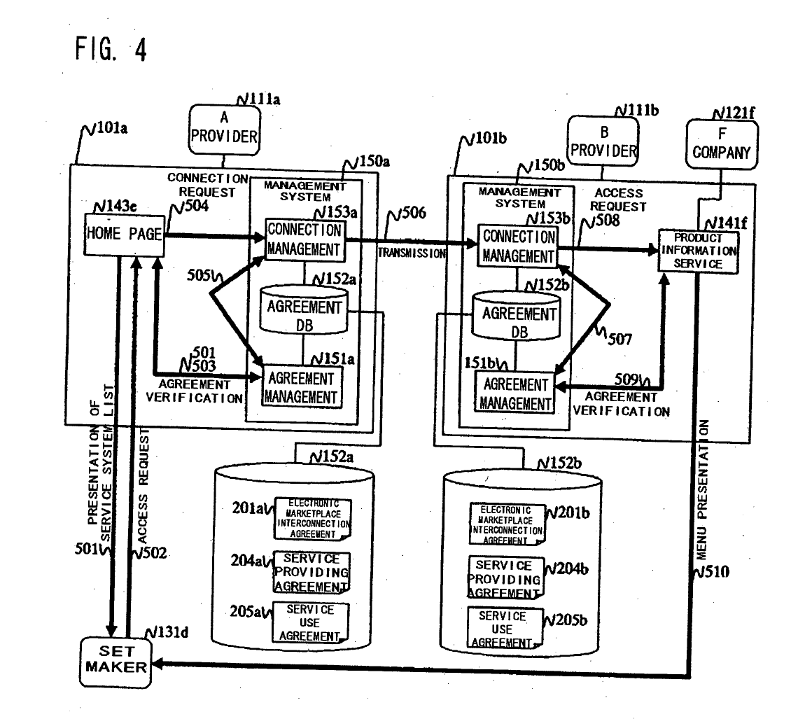

In FIG. 4, eMP1 (101a) and eMP2 (101b) are electronic marketplace centers provided by A and B providers 111a and 111b as electronic marketplace providers, which are similar in system configuration to the electronic marketplace center 101. A home page 143e is a service system which is provided by the A provider 111a, which is the electronic marketplace provider in the eMP1 (101a), as a service provider. The home page 143e provides a list of service systems which have service use agreements with users to the users of the eMP1 (101a). A product information service 141f is a service system in which an F company 121f as a parts maker or the like in the eMP2 (101b) provides information such as specifications regarding own products as a service provider. A set maker 131d uses the service systems provided in the eMP1 (101a) as a user of the eMP1 (101a).

It is assumed that in the agreement DB 152a and the agreement DB 152b of the eMP1 (101a) and the eMP2 (101b), by later-described agreement creation processing, an electronic marketplace interconnection agreement regarding the eMP1 (101a) and the eMP2 (101b) between the A provider 111a and the B provider 111b, a service providing agreement to provide the product information service 141f between the A provider 111a and the F company 121f also in the eMP1 (101a), and a service use agreement to use the product information service 141f between the set maker 131d and the F company 121f have been registered as electronic marketplace interconnection agreements 921 and 971, service providing agreements 1323 and 1374, and service use agreements 1424 and 1473. The service providing agreement is also a service interconnection agreement to provide the product information service 141f to the set maker 131d through the providing services of the home page 143e. It is further assumed that before the above registration, an electronic marketplace use agreement between the set maker 131d and the A provider 111a to use the eMP1 (101a), and a service providing agreement between the B provider 111b and the F company 121f to provide the product information service 141f in the eMP2 (101b) have been registered as an electronic marketplace use agreement 1224 and a service providing agreement 1373.

In the eMP1 (101a) and the eMP2 (101b), for example, service providing is carried out when the set maker 131d requests access to the product information service 141f through the list of service systems provided by the home page 143e. Hereinafter, processing regarding the service providing is described in detail.

First, the home page 143e makes an inquiry to the agreement management 151a to retrieve service systems which have service use agreements with the set maker 131d, and to present a list thereof to the set maker 131d (501). Specifically, in the retrieving of the service systems, a relevant service system is obtained which is indicated by the service name 1401, the provider name 1402, and the electronic marketplace name 1403 of agreement information in which the names of the set maker 131d and the eMP1 (101a) match the agreement information user name 1404 and the electronic marketplace name 1405 in the service use agreement 205a shown in FIG. 14A. In the embodiment, agreement information in 1424 matches the retrieval and the service system “product information service” provided by the “F company” in the electronic marketplace center “eMP1” is obtained as relevant.

The set maker 131d selects the “product information service” from the list provided in the processing 501 to request access (502).

The home page 143e makes an inquiry to the agreement management 151a to obtain the location of the “product information service” from the service providing agreement 204a (503). Specifically, the service name 1303, the provider name 1304 and the electronic marketplace name 1305 of agreement information are obtained as location information, in which the name “product information service” of the service system and the name “F company” of service provider thereof obtained in the processing 501 match the service name 1301 and the provider name 1302 of the agreement information in the service providing agreement 204a shown in FIG. 13A. The electronic marketplace name 1305 which is not the “eMP1” is a service system originally provided at the other electronic marketplace center. In the embodiment, agreement information 1323 matches retrieving, and the “product information service” provided by the “F company” in the electronic marketplace center “eMP2” is obtained as relevant.

The “product information service” is a service system originally provided in the eMP2 (101b) in the processing 503. Thus, the information of the “product information service” is passed together with the information of the set maker 131d to the interconnection management 153a to request access (504).

The interconnection management 153a makes an inquiry to the agreement management 151a to verify whether an agreement necessary between the electronic marketplace center and the service system which are access destinations has been registered in the agreement DB 152a based on the received information (505). In the verification, the presence of an electronic marketplace interconnection agreement with the eMP2 (101b) and the presence of a service providing agreement to provide the product information service 141f, which is provided between the F company 121f and the A provider 111a, in the eMP1 (101a) are determined. Specifically, in the verification of the electronic marketplace interconnection agreement, the presence of an agreement is determined if the name of the eMP2 (101b) matches the electronic marketplace name 901 of any one of the agreement information in the electronic marketplace interconnection agreement 201a shown in FIG. 9A. In the embodiment, because of the matching of agreement information 921, the presence of an agreement is determined. In the verification of a service providing agreement, the presence of an agreement is determined if the name “product information service” of the service system, the name “F company” of the service provider and the name “eMP2” of the electronic marketplace center passed in the processing 504 match the service name 1303, the provider name 1304 and the electronic marketplace name 1305 of any of the agreement information in the service providing agreement 204a shown in FIG. 13A. According to the embodiment, the presence of an agreement is determined because of the matching of agreement information 1323. In this case, based on the information of the service system verified in the processing 503 and passed in the processing 504, the verification of the service providing agreement in the processing 505 may be assumed to have completed.

If the presence of an agreement is verified in the processing 505, the interconnection management 153a creates interconnection message which contains an access request, and transmits the message to the eMP2 (101b) (506).

FIG. 7 shows an example of an interconnection message. A interconnection message 630 comprises an information part 631 which specifies transmitter and receiver electronic marketplace centers, an information part 632 (“service providing” in the embodiment) which specifies a kind of interconnection between the electronic marketplace centers, an information part 633 which specifies a service system to be accessed in service providing, an information part 634 to be understood and processed in a service system containing business data, and identifier information 635 of the set maker 131d.

Next, the process of receiving the interconnection message and presenting a processing menu which is a response to the access request of the product information service 141f in the eMP2 (101b) will be described in detail.

The interconnection management 153b obtains information regarding the transmitter electronic marketplace center, the kind of interconnection between the electronic marketplace centers (“service providing” in the embodiment), and the service system to be accessed in the service providing from the received interconnection message 630. Then, an inquiry is made to the agreement management 151b based on the information to verify whether an agreement necessary between the transmitter electronic marketplace center of the interconnection message 630 and the service system has been registered (507). In the verification, the presence of an electronic marketplace interconnection agreement with the eMP1 (101a) and a service providing agreement between the F company 121f which is the service provider of the product information service 141f and the A provider 111a. Specifically, in the verification of the electronic marketplace agreement, the presence of an agreement is determined if the name of the eMP1 (101a) matches the electronic marketplace name 951 of any one of the agreement information in the electronic marketplace interconnection agreement 201b shown in FIG. 9B. In the embodiment, because of the matching of agreement information 971, the presence of an agreement is determined. In the verification of a service providing agreement, the presence of an agreement is determined if the names of the product information service 141f and the F company 121f which is the service provider of the product information service 141f, and the name of the eMP1 (101a) which is the electronic marketplace center to make an access match the service name 1351, the provider name 1352, and the electronic marketplace name 1355 of any of the agreement information in the service interconnection agreement 204b shown in FIG. 13B. In the embodiment, the presence of an agreement is determined because of the matching of agreement information 1374.

If the presence of an agreement is verified in the processing 507, the interconnection management 153b extracts the information part 634 contained in the interconnection message and the identifier information 635 of the set maker 131d, to pass to the product information service 141f (508).

The product information service 141f makes an inquiry to the agreement management 151b to verify whether necessary agreement information has been registered in the agreement DB 152b (509). In the verification, the presence of a service use agreement is verified between the set maker 131d which is a user to request access and the F company 121f which is a service provider of the product information service 141f. Specifically, the presence of an agreement is determined if the combination of the names of the product information service 141f, the F company 121f which is the service provider thereof and the eMP2 (101b) which provides the product information service 141f with the names of the set maker 131d and the eMP1 (101a) which is an electronic marker place center used by the set maker 131d matches the service name 1451, the provider name 1452, the electronic marketplace name 1453, the user name 1454 and the electronic marketplace name 1455 of any of the agreement information in the service use agreement 205b shown in FIG. 14B. In the embodiment, the presence of an agreement is determined because of the matching of agreement information 1473.

If the presence of an agreement is verified in the processing 509, the product information service 141f presents a function menu for service use to the set maker 131d (510).

According to the service provideed by the present invention, the user of the service system can use the service system provided by the other electronic marketplace center through the currently used electronic market center. Thus, the number of used service systems can be increased without losing convenience.

Furthermore, regarding the service provider, if the existing service system is provided at another electronic market center, the provider can provide the service system with the service system without installing any new service systems at the electronic marketplace center. Thus, the number of users can be increased without increasing service providing costs such as system development or construction. Regarding the electronic marketplace provider, as in the case of the effects regarding the service provider, it is not necessary to secure space for installing the service system or carry out administrative control. Thus, the electronic marketplace center can be provided to the user and the service provider at low costs.

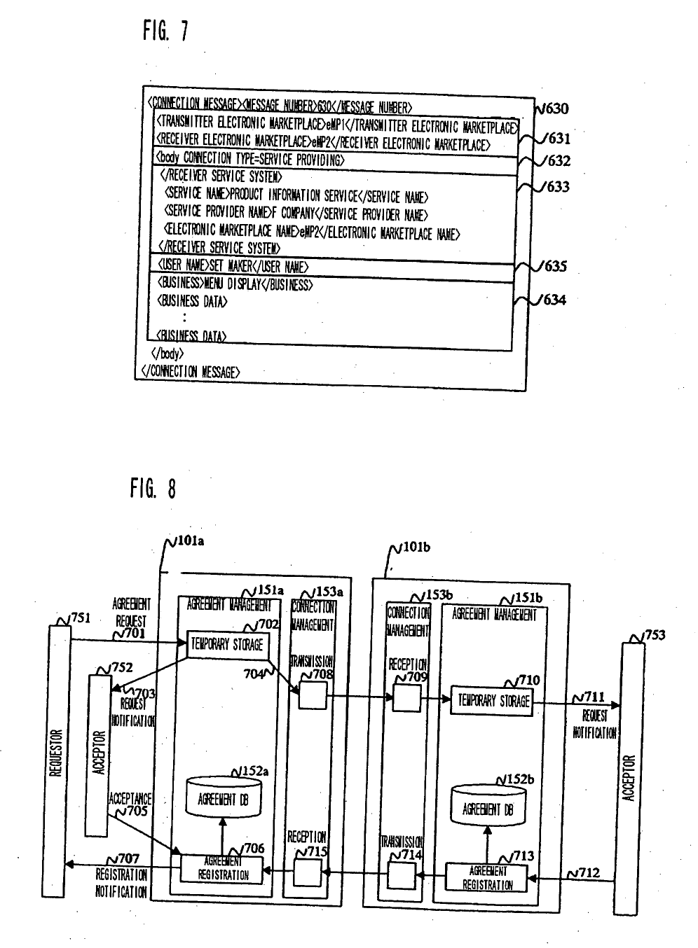

Detailed description will be made of the processing of registering agreement information in the interconnection between the electronic marketplaces (agreement creation process) which becomes necessary in the electronic marketplace center or over the electronic marketplace center. FIG. 8 shows an example of a processing flow regarding the process of agreement creation. In FIG. 8, agreement information in the electronic marketplace center is registered between any one (requestor 751) of participants 110a in the eMP1 (101a) and any one (acceptor 752) of the participants 110a in the eMP1 (110a), and agreement information over the electronic marketplace centers is registered between any one (requestor 751) of the participants 110a in the eMP1 (101a) and any one (acceptor 753) of participants 110b in the eMP2 (101b). Hereinafter, each processing is described in detail.

First, the requester 751 requests the agreement management 151a to register agreement information with the acceptor 752 or 753 (701). The contents of the request include the name of the requestor 751, the name of the acceptor 752 or 753, the name(s) of an electronic marketplace center used or provided by them, an agreement information name, and agreement conditions. Furthermore, the contents comprise the name of-a service system provided by the requestor 751, the acceptor 752, or the acceptor 753 in accordance with the necessity of agreement information.

The agreement management 151a temporarily stores the contents of the request (702), and notifies the arrival of the agreement registration request if the target of an agreement is any one (acceptor 752) of the participants 110a in the same electronic marketplace center based on the name of the electronic marketplace center used or provided by the acceptor 752 or 753 contained in the request of the processing 701 (703). If the target of the agreement is any one (acceptor 753) of the participants 110b in another electronic marketplace center, the contents of the request are sent to the interconnection management 153a to request its transmission to the electronic marketplace center eMP2 (101b) used by the acceptor 753 (704).

Upon notification in the processing 703, the acceptor 752 accesses the agreement management 151a to refer to the contents of the request temporarily stored in the processing 702, and accepts or rejects the request (705).

The agreement management 151a which has received acceptance in the processing 705 registers the contents of the request temporarily stored in the processing 702 as an agreement which indicates agreements of both of the requestor 751 and the acceptor 752 in the agreement DB 152a (706), and then notifies the registration of the agreement information to the requestor 751 (707). Here, if the request is rejected in the processing 705, the agreement management 151a does not register the agreement information, but notifies the rejection to the requestor 751.

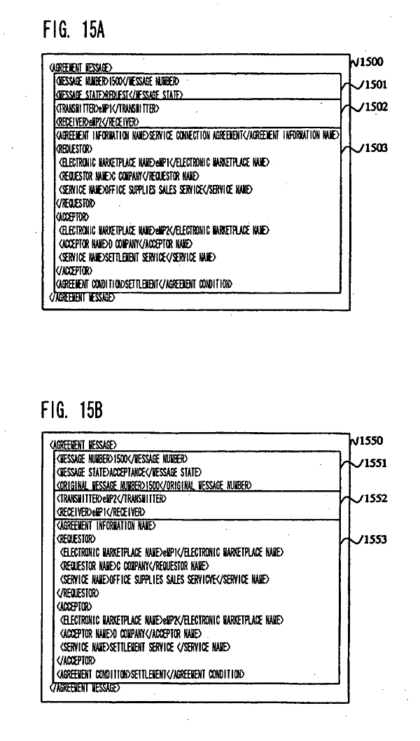

The interconnection management 153a which has received the request in the processing 704 creates a message (agreement message) to request the registration of the agreement information based on the request, and transmits the message to the eMP2 (101b) (708). FIG. 15A shows an example of an agreement message created in the eMP1 (101a). A agreement message 1500 comprises an identifier to specify the agreement message, an information part 1501 which indicates whether the message is a registration request of the agreement information and its acceptance or rejection (“request” in the embodiment), an information part 1502 to specify transmitter and receiver electronic marketplace centers, and a request contents part 1503 of the processing 701.

The interconnection management 153b in the eMP2 (101b) receives the agreement message 1500, and sends it to the agreement management 151b (709).

In the agreement management 151b, the request contents are extracted from the agreement message, temporarily stored (710), and the arrival of the request of agreement registration is notified to the relevant acceptor 753 (“D company” according to the embodiment) (711).

The acceptor 753 which has received the notice accesses the agreement management 151b, refers to the request contents temporarily stored in the processing 702, and accepts or rejects the request (712).

The agreement management 151b which has received acceptance in the processing 712 registers the request contents temporarily stored in the processing 710 as an agreement indicating agreements of both of the requester 751 and the acceptor 753 in the agreement DB 152b (713), and requests the interconnection management 153b to notify the acceptance to the agreement management 151a of the eMP1 (101a). Here, if the request is rejected in the processing 712, the agreement management 151b does not register the agreement information, but requests the interconnection management 153b to notify the rejection to the agreement management 151a of the eMP1 (101a).

The interconnection management 153b creates an agreement message to notify the acceptance or rejection of the agreement information based on the request and transmits it to the eMP1 (101a) (714). FIG. 15B shows an example of an agreement message created in the eMP2 (101b). A agreement message 1550 comprises an identifier to specify the agreement message, an information part 1551 which indicates acceptance or rejection to the registration request of the agreement information (“acceptance” in the embodiment), an information part 1552 to specify transmitter and receiver electronic marketplace centers, and a request contents part 1553 of the request contents temporarily stored in the processing 710.

The interconnection management 153a in the eMP1 (101a) receives the agreement message 1550 and passes it to the agreement management 151a (715).

In the agreement management 151a, the information part 1551 of the agreement message 1550 received in the processing 715 is verified. In the case of “acceptance”, the request contents temporarily stored in the processing 702 are registered as an agreement indicating agreements of both of the requestor 751 and the acceptor 753 in the agreement DB 152b (706) The agreement information requested in the processing 701 is accepted by the acceptor 753, and its registration in the agreement DB 152a in the relevant electronic marketplace center is notified to the requester 751 (707). In the case of “rejection”, the agreement management 151a does not register the agreement information, but notifies the rejection to the requester 751.

In the examples of the agreement messages shown in FIGS. 15A and 15B, the agreement information registered in the service interconnection agreement 202a of the eMP1 (101a) is equivalent to the agreement information 1022 of FIG. 1A, and the agreement information registered in the service interconnection agreement 202b of the other eMP2 (101b) is equivalent to the agreement information 1072 of FIG. 10B.

In the aforementioned agreement creation, in order to improve the convenience of the agreement creation, for example, if the electronic marketplace provider and the service provider are the same, an electronic marketplace use agreement and a service use agreement may be simultaneously registered when the user simultaneously makes agreements for using the electronic marketplace center and using the service system provided by the electronic marketplace provider as the service provider.

Each of the foregoing embodiments can be implemented by using a computer system such as a personal computer. In such a case, in the processing procedures shown in FIGS. 2 to 4 and FIG. 8, are stored in a storage medium as programs to be read by the computer system and, in the execution of the processing, the program is read from the storage medium to be executed at a central processing unit when necessary. Additionally, regarding data such as agreement information to be handled in each processing, the data is written/read by using a storage medium readable by the computer system.

According to the present invention, the business data interchange enables the user of the service system to carry out trades with the customer who uses another electronic marketplace center through the currently used electronic marketplace center and service system. Thus, there is no need to prepare an environment for connection to a service system or an electronic market center in accordance with a customer such as a new customer, or change a connection target, and work can be simplified. At the same time, information exchange and work can be carried out without increasing work costs.

According to the present invention, the use rate of the service system by the user is increased, whereby the service provider or the electronic marketplace provider can activate services or the electronic marketplace and increase profits which accompany the use of services and the electronic marketplace. Additionally, since it is not necessary to increase users who have direct agreements, the number of users can be increased without increasing sales expansion costs.

According to the present invention, the business process connection of the present invention enables the user of the service system to consistently carry out business operations provided by a plurality of electronic marketplace centers and service systems. Thus, it is possible to enhance business operation convenience and efficiency.

According to the present invention, by providing an environment in which a plurality of business operations can be consistently carried out, the service provider of the service system or the electronic marketplace provider of the electronic marketplace center can differentiate the service system or the electronic marketplace from the other service system or the other electronic marketplace center and provide additional values, and thus, attracting users and increasing profits.

According to the present invention, the user of the service system can use the service system provided by the other electronic marketplace center through the currently used electronic market center. Thus, the number of service systems to be used can be increased without losing convenience.

Furthermore, according to the present invention, regarding the service provider, if the existing service system is provided at another electronic market center, the service system can be provided without installing any new service systems at the electronic marketplace center. Thus, the number of users can be increased without increasing service providing costs such as system development or construction. Regarding the electronic marketplace provider, as in the case of the effects regarding the service provider, it is not necessary to secure space for installing the service system or carry out administrative control. Thus, the electronic marketplace center can be provided to the user and the service provider at low costs.

Although the preferred embodiment of the present invention has been described in detail, it should be understood that various changes, substitutions and alterations can be made therein without departing from the spirit and scope of the invention as defined by the appended claims.

What is claimed is:

1. An electronic marketplace system for providing an electronic exchange to a user through a network, comprising:
a service system for providing services to a user who participates in the electronic marketplace system;
a memory for storing electronic marketplace interconnection agreement information between a provider of the electronic marketplace system and a provider of another electronic marketplace system and inter-participant agreement information between a participant including a provider of said service system and said user and another participant including a provider of another service system that participates in said another electronic marketplace system and a user thereof; and
a management system for determining whether trades between the participant and the other participant should be permitted based on presence of the electronic marketplace interconnection agreement information and the inter-participant agreement information.

2. An electronic marketplace interconnection method for connecting a first electronic marketplace system with a second electronic marketplace system, comprising:
storing electronic marketplace interconnection agreement information made between a provider of said first electronic marketplace system and a provider of said second electronic marketplace system and inter-participant agreement information between a provider of a first participant including a service system provider who participates in said first electronic marketplace system and a first user and a second participant including a provider of a second service system who participates in said second electronic marketplace and a second user in said first electronic marketplace system; and
determining whether interconnection should be permitted between said first electronic marketplace system and said second electronic marketplace system based on presence of said electronic marketplace interconnection agreement information and said inter-participant agreement information by said first electronic marketplace system.

3. An electronic marketplace system for providing an electronic exchange to a user through a network, comprising:
a service system for providing services to a user who participates in said electronic marketplace system;
a memory for storing electronic marketplace interconnection agreement information which includes an identifier of another electronic marketplace system which can be connected with said electronic marketplace system, service interconnection agreement information which includes an identifier of said service system, and another identifier of another service system of another electronic marketplace system which can be connected with said service system, and trading agreement information which includes said identifier of said user and an identifier of another user who participates in another electronic marketplace system capable of trades with said user; and
a management system, said management system
determining whether an identifier of another electronic marketplace system in which another user participates is included in the electronic marketplace interconnection agreement information in the memory, determining whether an identifier of another service system for providing services regarding said trades to another user is included in said service interconnection agreement information in said memory, determining whether an identifier of another user is included in said trading agreement information in said memory when said user requests trades with another user,
said management system generating a message to request interconnection with another electronic marketplace system and transmitting said message to another electronic marketplace system when it is determined that said identifier of another electronic market place system is included in said electronic market place interconnection agreement information, said identifier of another service system is included in said service interconnection agreement information, and said identifier of another user is included in said trading agreement information.

4. An electronic marketplace system according to claim 3,
wherein said memory includes service use agreement information which includes an identifier of a user who can use services provided by said service system, and
said management system determines whether said identifier of said user is included in said service use agreement information in said memory and transmits said message to said other electronic marketplace system if it is determined that said identifier of said user is included in said service use agreement information.

5. An electronic marketplace system according to claim 3,
wherein said message includes transmitter electronic marketplace system information including said identifier of said electronic marketplace system, receiver electronic marketplace system information including said identifier of another electronic marketplace system, transmitter service system information including said identifier of said service system, receiver service system information which contains said identifier of said other service system, transmitter user information including said identifier of said user, receiver user information which contains said identifier of said other user, and interconnection type information which defines an interconnection target between said electronic marketplace system and another electronic marketplace system.

6. An electronic marketplace interconnection method for connecting a first electronic marketplace system with a second electronic marketplace system, comprising:
storing electronic marketplace interconnection agreement information including an identifier of said second electronic marketplace system which can be connected with said first electronic marketplace system, service interconnection agreement information including an identifier of a first service system which participates in said first electronic marketplace system, and an identifier of a second service system which participates in said second electronic marketplace system which can be connected with said first service system, and trading agreement information including an identifier of said first user who participates in said first electronic marketplace system, and an identifier of a second user who participates in said second electronic marketplace system capable of trading with said first user, in said first electronic market system;
determining, when said first user requests trades with said second user, whether said identifier of said second electronic marketplace system in which said second user participates is included in said electronic marketplace interconnection agreement information in said memory, determining whether said identifier of said second service system for providing services regarding said trades to said second user is included in said service interconnection agreement information in said memory, and determining whether said identifier of said second user is included in said trading agreement information in said memory by said first electronic marketplace system;
generating a message to request interconnection with said second electronic marketplace system by said first electronic marketplace system when it is determined that said identifier of said second electronic marketplace system is included in said electronic marketplace interconnection agreement information, said identifier of said second service system is included in said service interconnection agreement information, and said identifier of said second user is included in said trading agreement information; and
transmitting said message from said first electronic marketplace system to said second electronic marketplace system.

7. An electronic marketplace system for providing an electronic exchange to a user through a network, comprising:
a service system for providing services to a user who participates in said electronic marketplace system;
a memory for storing electronic marketplace interconnection agreement information including an identifier of another electronic marketplace system which can be connected with said electronic marketplace system, service interconnection agreement information including an identifier of said service system, and an identifier of another service system of another electronic marketplace system which can be connected with said service system, and electronic marketplace use agreement information including an identifier of said user and an identifier of another electronic marketplace system in which said user can participate; and
a management system, said management system,
when said user requests providing of services from said another service system, determining whether an identifier of said other electronic marketplace system in which said other service system participates is included in electronic marketplace interconnection agreement information and said electronic marketplace use agreement information in said memory, determining whether an identifier of said another service system is included in said service interconnection agreement information in said memory,
said management system generating a message to request interconnection with another electronic marketplace system and transmitting said message to another electronic marketplace system when it is determined that said identifier of said another electronic marketplace system is included in said electronic marketplace interconnection agreement information and said electronic marketplace use agreement information.

8. An electronic marketplace system according to claim 7,
wherein said memory includes service use agreement information including an identifier of a user who can use services provided by said service system, and
said management system determines whether said identifier of said user is included in said service use agreement information in said memory and transmits said message to said another electronic marketplace system if it is determined that said identifier of said user is included in said service use agreement information.

9. An electronic marketplace system according to claim 7,
wherein said message includes transmitter electronic marketplace system information including said identifier of said electronic marketplace system, receiver electronic marketplace system information including said identifier of said another electronic marketplace system, transmitter service system information which contains said identifier of said service system, receiver service system information including said identifier of said another service system, service receiver information which includes said identifier of said user and said identifier of said service system, and interconnection type information which defines an interconnection target between said electronic marketplace system and said another electronic marketplace system.

10. An electronic marketplace interconnection method for connecting a first electronic marketplace system with a second electronic marketplace system, comprising:
storing electronic marketplace interconnection agreement information including an identifier of said second electronic marketplace system which can be connected with said first electronic marketplace system, service interconnection agreement information including an identifier of a first service system, which participates in said first electronic marketplace system, and an identifier of a second service system which participates in said second electronic marketplace system which can be connected with said first service system, and electronic marketplace use agreement information including an identifier of said user and an identifier of said another electronic marketplace system in which said user can participate, in said first electronic market system;
determining, when a first user requests providing of services from said second-service system, whether an identifier of said second electronic marketplace system in which said second service system participates is included in said electronic marketplace interconnection agreement information and said electronic marketplace use agreement information in said memory, and determining whether an identifier of said second service system is included in said service interconnection agreement information in said memory by said first electronic marketplace system;
generating a message to request interconnection with said second electronic marketplace system by said first electronic marketplace system if it is determined that said identifier of said second electronic marketplace system is included in said electronic marketplace interconnection agreement information and said electronic marketplace use agreement information in said memory, and said identifier of said second service system is contained in said service interconnection agreement information; and
transmitting said message from said first electronic marketplace system to said second electronic marketplace system.

11. An electronic marketplace system for providing an electronic exchange to a user through a network, comprising:
a service system for providing services to a user who participates in said electronic marketplace system;
a memory for storing electronic marketplace interconnection agreement information which contains an identifier of another electronic marketplace system which can be connected with said electronic marketplace system, service providing agreement information including an identifier of another service system of said another electronic marketplace system which can provide a service to said electronic marketplace service system, and service use agreement information including an identifier of said user and an identifier of said another service system which can provide said services to said user; and
a management system, said management system
when said user requests providing of services from said other service system, determining whether an identifier of said other electronic marketplace system in which said another service system participates is included in said electronic marketplace interconnection agreement information in said memory and determining whether said identifier of said other service system is included in said service providing agreement information in said memory,
said management system generating a message to request interconnection with said other electronic marketplace system and transmitting said message to said another electronic marketplace system when it is determined that said identifier of said another electronic marketplace system is included in said electronic marketplace interconnection agreement information, and said identifier of said other service system is contained in said service providing agreement information, and said service use agreement information.

12. An electronic marketplace system according to claim 11,
wherein said message includes transmitter electronic marketplace system information having said identifier of said electronic marketplace system, receiver electronic marketplace system information having said identifier of said another electronic marketplace system, transmitter service system information having said identifier of said another service system, user information having said identifier of said user, and interconnection type information which defines an interconnection target between said electronic marketplace system and said another electronic marketplace system.

13. An electronic marketplace interconnection method for connecting a first electronic marketplace system with a second electronic marketplace system, comprising:
storing electronic marketplace interconnection agreement information including an identifier of said second electronic marketplace system which can be connected with said first electronic marketplace system, service providing agreement information including an identifier of a second service system of said second electronic marketplace system which can provide services to said first electronic marketplace system, and service use agreement information including an identifier of said user and an identifier of said second service system which can provide said services to said user in said first electronic market system;
determining, when said user requests providing of services from said second service system, whether said identifier of said second electronic marketplace system in which said second service system participates is included in said electronic marketplace interconnection agreement information in said memory and determining whether said identifier of said second service system is included in said service providing agreement information and said service use agreement information in said memory by said first electronic marketplace system;
generating a message to request interconnection with said second electronic marketplace system by said first electronic marketplace system if a management system of said first electronic marketplace system determines that said identifier of said second electronic marketplace system is included in said electronic marketplace interconnection agreement information and said identifier of said second service system is included in said service providing agreement information and said service use agreement information; and
transmitting said message from said first electronic marketplace system to said second electronic marketplace system.

14. An electronic marketplace interconnection method for connecting a first electronic marketplace system which provides various kinds of business services through a network with a second electronic marketplace system, comprising:
storing agreement information which includes; electronic marketplace interconnection agreement information exchanged between a provider of said first electronic marketplace system and said second electronic marketplace system to transfer various kinds of information between said first electronic marketplace system and said second marketplace system, service interconnection agreement information exchanged between a provider of a first service system and a provider of a second service system to transfer business information between said first service system which provides business services in said first electronic marketplace system and said second service system which provides business services in said second electronic marketplace system, electronic marketplace use agreement information exchanged between a first user and said provider of said first electronic marketplace system to use said first electronic marketplace system, service providing agreement information exchanged between said provider of said first service system and said provider of said first electronic marketplace system to provide business services in said first electronic marketplace system, service use agreement information exchanged between said first user and said provider of said first service system to utilize business services provided by said first electronic marketplace system, and trading agreement information exchanged between said first user and a second user to carry out business with said second user who uses said second service system by making use of an information transfer function of said first service system; and
referring to said agreement information when at least one selected from; business data interchange for transferring business data between said first service system and said second service system, business process connection for requesting business processing carried out by each of said service systems and responding to a request, and service providing for providing said services of said first service system in said second electronic marketplace system, is carried out and transferring business information between said first electronic marketplace system and said second electronic marketplace system if presence of said agreement information is verified.
